(19) United States
(12) Patent Application Publication
(10) Pub. No.: US 2016/0266843 A1
(43) Pub. Date: Sep. 15, 2016

(54) MEMORY DEVICE, COMMUNICATION DEVICE, AND MEMORY CONTROLLER

(71) Applicant: Kabushiki Kaisha Toshiba, Minato-ku (JP)

(72) Inventor: Ryuichi KITAJIMA, Funabashi (JP)

(73) Assignee: Kabushiki Kaisha Toshiba, Minato-ku (JP)

(21) Appl. No.: 14/721,396

(22) Filed: May 26, 2015

Related U.S. Application Data
(60) Provisional application No. 62/130,310, filed on Mar. 9, 2015.

(51) Int. Cl. G06F 3/06; H01F 38/14

(52) U.S. Cl. CPC G06F 3/0647; H01F 38/14; G06F 3/0604; G06F 3/0688; H01F 2038/143

(57) ABSTRACT

According to one embodiment, a memory device includes a non-volatile first memory, a non-volatile second memory, a first controller, and a second controller as one example. The first controller writes, upon receipt of control information by a communication unit, the control information to the first memory. The control information defines an operation regarding a data file stored in the second memory. The second controller executes the control information after a start of the memory device.

### CROSS-REFERENCE TO RELATED APPLICATIONS

This application is based upon and claims the benefit of priority from U.S. Provisional Application No. 62/130,310, filed on Mar. 9, 2015; the entire contents of which are incorporated herein by reference.

### FIELD

Embodiments described herein relate generally to a memory device, a communication device, and a memory controller.

### BACKGROUND

Recently, there has been disclosed a technique regarding a memory card equipped with a Near Field Communication (NFC). The memory card equipped with the NFC function includes an NFC tag in addition to a non-volatile memory. The NFC tag includes an antenna for NFC and an NFC controller.

### BRIEF DESCRIPTION OF THE DRAWINGS

FIG. 1 is a block diagram illustrating an exemplary internal constitution of a memory card according to a first embodiment;

FIG. 2 is a block diagram illustrating an exemplary functional configuration of a mobile terminal according to the first embodiment;

FIG. 3 is a drawing illustrating an exemplary configuration of a program input screen displayed on the mobile terminal in the first embodiment;

FIG. 4 is a drawing illustrating a display example of a build result displayed in a notification area in the first embodiment;

FIG. 5 is an explanatory view schematically illustrating an exemplary operation of writing an execution file of a program on an EEPROM according to the first embodiment;

FIG. 6 is a flowchart illustrating an exemplary operation process when starting a memory card in the first embodiment;

FIG. 7 is a drawing illustrating an exemplary configuration of a command input screen displayed on the mobile terminal in a second embodiment;

FIG. 8 is an explanatory view schematically illustrating an exemplary operation of writing a command on the EEPROM in the second embodiment;

FIG. 9 is a setting example of a command table;

FIG. 10 is a setting example of command information;

FIG. 11 is a setting example of a command ID;

FIG. 12 is a flowchart illustrating an exemplary operation process when starting the memory card in the second embodiment; and

FIG. 13 is a schematic diagram illustrating an exemplary operation method when accepting a user instruction through a touch operation.

### DETAILED DESCRIPTION

In general, according to one embodiment, a memory device includes a communication unit, a first memory, a second memory, a first controller, and a second controller. The communication unit is configured to perform a near field communication. The first memory is configured to be a non-volatile memory accessible by the near field communication. The second memory is configured to be a non-volatile memory that can store a data file. The first controller is configured to write, upon receipt of control information by the communication unit, the received control information to the first memory using electric power generated during the near field communication regardless of whether the memory device has been started or not. The control information defines an operation regarding the data file. The second controller is configured to read the control information from the first memory after the start of the memory device and to execute the control information.

Exemplary embodiments of a memory device, a communication device, and a memory controller will be explained below in detail with reference to the accompanying drawings. The present invention is not limited to the following embodiments.

### First Embodiment

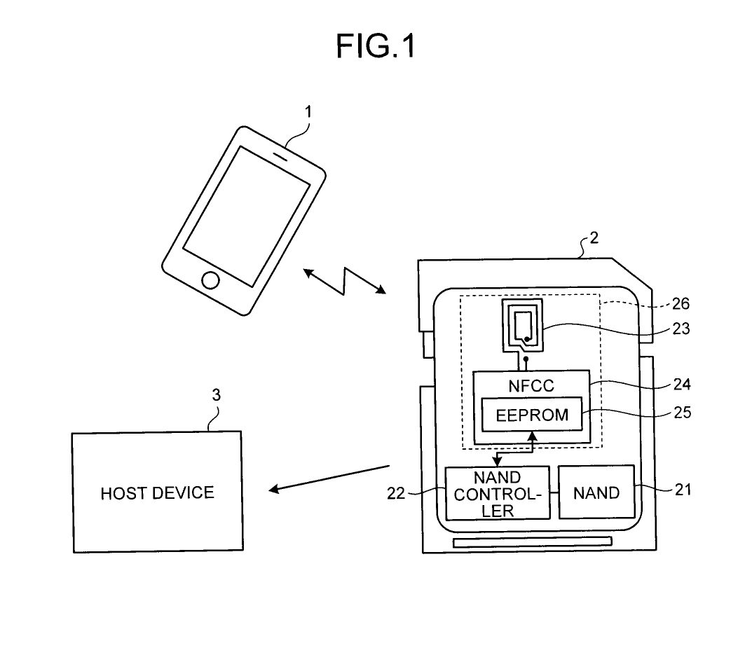

FIG. 1 is a block diagram illustrating an exemplary internal constitution of a memory card 2 according to a first embodiment. The memory card 2 has a near field communication function of a Near Field Communication (NFC) standard. As the near field communication function, other standards, Transfer Jet (registered trademark), Bluetooth (registered trademark), and the like may be used. This embodiment describes an example of using an SD card as the memory card 2. However, the memory card 2 is not limited to this. As other configurations, a Universal Serial Bus (USB) memory, a Subscriber Identity Module Card (SIM) card, an Integrated Circuit (IC) card, and the like may be used as the memory card 2.

A host device 3 for the memory card 2 includes a card slot of an identical standard to the memory card 2. When inserting the memory card 2 into the card slot, the host device 3 accesses the memory card 2 to record and read data. As the host device 3, for example, an information processing terminal, a Personal Computer (PC), a digital camera, and the like can be used.

A mobile terminal 1 is a communication device having the near field communication function of the NFC standard. As the mobile terminal 1, a smart phone, a tablet terminal, and the like can be used. However, as long as the communication device has the NFC function, other electronic devices may be used.

The following describes the configuration of the memory card 2 in detail.

The memory card 2 includes a NAND flash memory (hereinafter abbreviated as a NAND) 21, which is a non-volatile memory, and a NAND controller 22, which controls the NAND 21. The memory card 2 includes an NFC tag 26. The NFC tag 26 includes an NFC-compliant antenna 23, an NFC controller (NFCC) 24, and an Electrically Erasable Programmable Read-Only Memory (EEPROM) 25, which is a non-volatile temporary memory. The EEPROM 25 functions as a non-volatile first memory, and the NFCC 24 functions as a first controller. The NAND 21 functions as a non-volatile second memory, and the NAND controller 22 functions as a second controller.

The NAND 21 includes one or plural memory chips. The NAND 21 stores and retains user data (data file) written by the host device 3 in this memory chip. Each memory chip includes a memory cell array where plural memory cells are arrayed in a matrix. Individual memory cells allow multi-valued storage. In each memory chip, plural physical blocks are arrayed, which is a unit of data deletion. One physical block has plural physical pages. The NAND 21 writes and reads data per physical page.

The memory card 2 includes plural terminals (not illustrated). When inserting the memory card 2 into the card slot of the host device 3, these terminals are coupled to terminals on the host device 3 side disposed in the card slot. When inserting the memory card 2 into the card slot of the host device 3, the NAND controller 22 executes a command process corresponding to various commands received from the host device 3 via these terminals. This command process includes a process of reading data from the NAND 21, a process of writing data to the NAND 21, or the like. The NAND controller 22 controls the NAND 21 using management information: logical/physical conversion information, indicative of a mapping of a logical address used in the host device 3 and the physical address of the NAND 21 used in the memory card 2, and the like. Besides, the NAND controller 22 executes internal processing: a garbage collection process, a wear leveling process, and the like on the NAND 21.

When the memory card 2 is inserted into the card slot of the host device 3 and terminates an initialization process at the start, the NAND controller 22 reads and executes the program written to the EEPROM 25.

The antenna 23 is an antenna for NFC communications. The antenna 23 functions as a communication unit that performs information communications with an NFC-compliant antenna of the mobile terminal 1 approaching the memory card 2.

The EEPROM 25 is writable non-volatile memory and is coupled to the NFCC 24 and the NAND controller 22. The mobile terminal 1 is accessible to the EEPROM 25 by the NFC. Meanwhile, even if inserting the memory card 2 into the card slot of the host device 3, the host device 3 cannot access the EEPROM 25.

The EEPROM 25 functions as the first memory accessible by NFC. The EEPROM 25 stores control information received from the mobile terminal 1 by NFC. Here, the control information is a computer program (simply referred to as a program) and a command defining an operation regarding the data file stored in the NAND 21. The first embodiment describes an example of application of the program in an executable format as the control information. The second embodiment describes an example of application of the command executed while sequentially interpreted as the control information.

The configuration of the first memory is not limited to the EEPROM. As long as the memory ensures low capacity, low power consumption, and high speed access more than the NAND 21, the memory card 2 may include a memory other than the EEPROM as the first memory.

The NFCC 24 performs data transmission and reception with the mobile terminal 1 via the antenna 23 by NFC. This allows an application of the mobile terminal 1 to access the EEPROM 25 via the NFCC 24 to read and write data.

The NFC tag 26 is operable under the condition where a power source is not supplied to the memory card 2. That is, when the NFC-compliant mobile terminal 1 approaches the antenna 23, a magnetic field is generated from the mobile terminal 1. This magnetic field generates induced electromotive force on the antenna 23. The NFCC 24 and the EEPROM 25 can perform various operations using thus generated induced electromotive force. Therefore, even if the memory card 2 is not inserted into the card slot, that is, even if the power source is not supplied to the memory card 2, the application of the mobile terminal 1 can read/write the data to the EEPROM 25.

The following describes the configuration of the mobile terminal 1 in more detail.

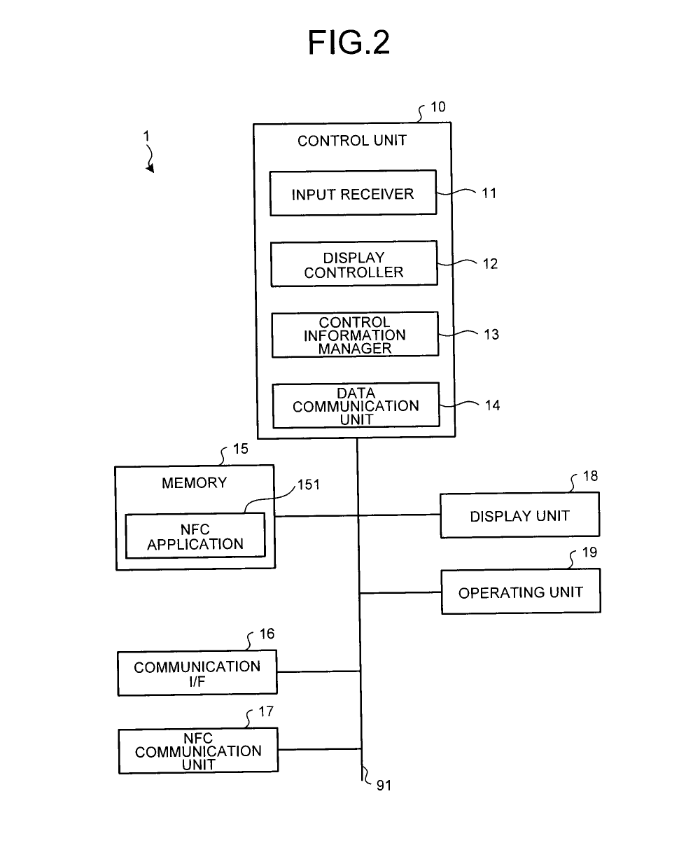

FIG. 2 is a block diagram illustrating the functional configuration of the mobile terminal 1 according to the first embodiment. The mobile terminal 1 includes a control unit 10 with a configuration of a computer, a Central Processing Unit (CPU), a Read Only Memory (ROM), a Random Access Memory (RAM), and the like. The configuration of the control unit 10 should not be construed in a limiting sense. It is only necessary for the control unit 10 to have a hardware configuration with equivalent functions.

The control unit 10 is coupled to a non-volatile memory 15, a flash memory and the like, via a bus 91. The memory 15 is a memory device for storing application programs executed by the mobile terminal 1, the user data or the like. The memory 15 of this embodiment stores an NFC application 151, which is an application program for NFC process.

The control unit 10 is coupled to a communication I/F (Interface) 16 for coupling to various communications networks via the bus 91. The control unit 10 is coupled to an NFC communication unit 17 via the bus 91. The NFC communication unit 17 performs data communications with a NFC tag and an NFC-compliant device by NFC. The control unit 10 is coupled to a display unit 18 and an operating unit 19 via the bus 91, respectively. The display unit 18 is a display device, a Liquid Crystal Display (LCD) and the like. A touchscreen is disposed on the display surface of the display unit 18. This touchscreen functions as the operating unit 19.

The following describes the functional configuration of the control unit 10. The control unit 10 reads the NFC application 151 from the memory 15 to develop the NFC application 151 on the working memory of the control unit 10 for execution. Thus, the control unit 10 achieves functions as an input receiver 11, a display controller 12, a control information manager 13, and a data communication unit 14 as illustrated in FIG. 2.

The input receiver 11 accepts an input of various information according to an operation in the operating unit 19. More specifically, the input receiver 11 accepts a text input and various user instructions via inputs from an on-screen keyboard displayed on the display unit 18 and various operation keys. The input receiver 11 may accept various information via a handwriting input, a voice input, or the like. In the case of using the voice input, the mobile terminal 1 is assumed to have a microphone function as the operating unit 19.

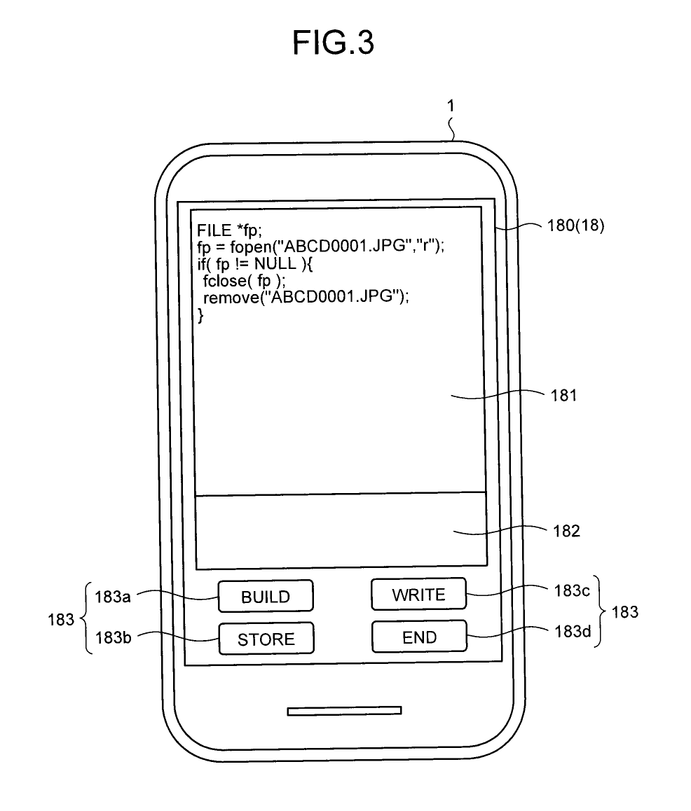

The display controller 12 controls display operations in the display unit 18. For example, when starting the NFC application 151, the display controller 12 displays a program input screen 180 as illustrated in FIG. 3 on the display unit 18.

FIG. 3 is a drawing illustrating an configuration example of the program input screen 180 displayed on the mobile terminal 1 in the first embodiment. The program input screen 180 includes a program area 181, a notification area 182, and various operation keys 183. The program area 181 is an area that displays the program input via the operating unit 19. In the example of FIG. 3, a program of deleting “ABCD0001.JPG” stored in the NAND 21 of the memory card 2 is described. Here, the file “ABCD0001.JPG” is a file accessible by the host device 3 while the memory card 2 is inserted into the card slot of the host device 3.

The notification area 182 is an area that notifies a compilation result on a program input to the program area 181.

The operation key 183 includes a build key 183a, a store key 183b, a write key 183c, and an end key 183d. The key configuration is one example. The operation key having another function may further be disposed. The build key 183a is a key to compile the program input to the program area 181 and accept an instruction of generating the execution file. The store key 183b is a key to accept an instruction of storing the program input to the program area 181.

The write key 183c is a key to accept an instruction of writing the generated execution file to the EEPROM 25 of the memory card 2 via the NFC. The end key 183d is a key to accept an instruction of terminating the NFC application 151. When selecting and operating the end key 183d, the display controller 12 terminates the NFC application 151 to terminate the display of the program input screen 180.

When selecting and operating the build key 183a, the control information manager 13 (see FIG. 2), compiles the program input to the program area 181 to generate the execution file. That is, the control information manager 13 functions as a converter that converts a program input by a user into the execution file. The control information manager 13 notifies the display controller 12 of the build result. When selecting and operating the store key 183b, the control information manager 13 stores the program input to the program area 181 in the memory 15.

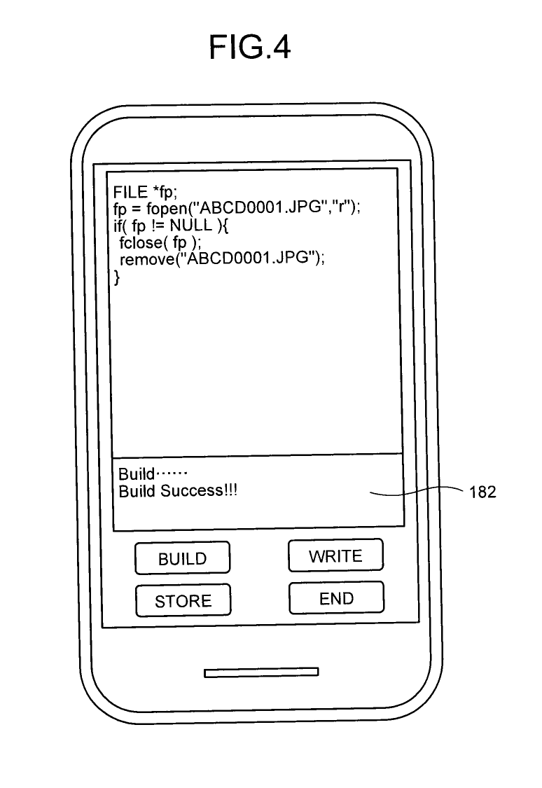

FIG. 4 is a drawing illustrating a display example of a build result displayed in a notification area 182 in the first embodiment. Based on the notification content by the control information manager 13, the display controller 12 displays whether the build has succeeded or not on the notification area 182. The example of FIG. 4 displays the notification of accepting a build instruction and the notification of succeeding the build.

When selecting and operating the write key 183c, the data communication unit 14 (see FIG. 2) transmits the execution file generated by the control information manager 13 to the memory card 2 via the NFC communication unit 17.

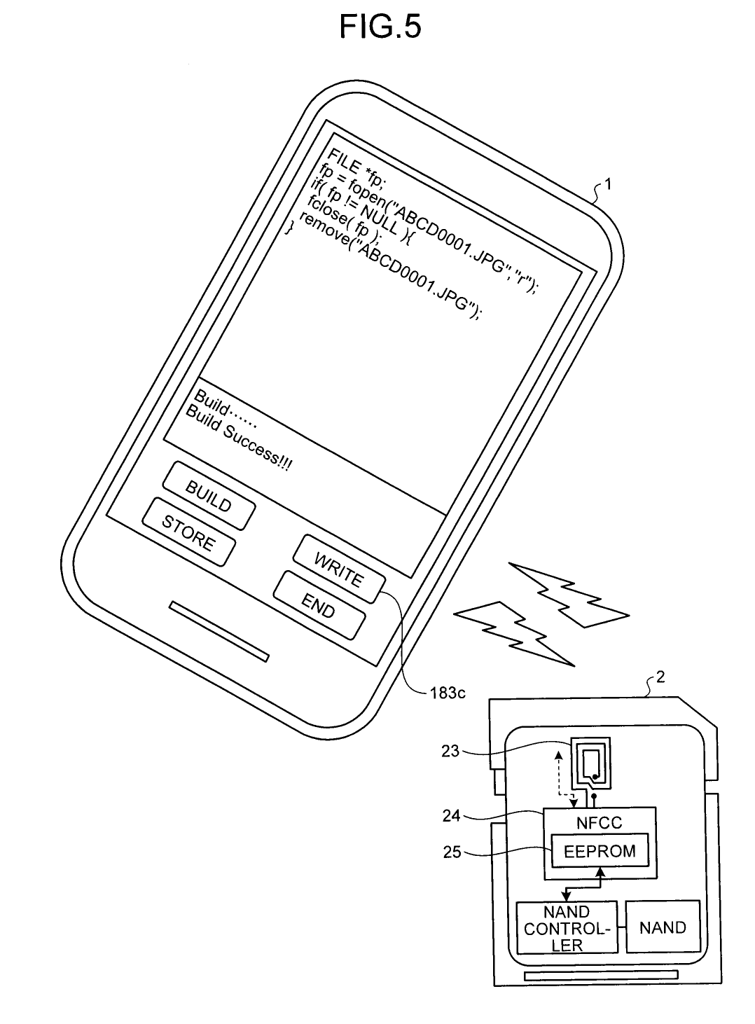

FIG. 5 is an explanatory view schematically illustrating the operation of writing the execution file of the program on the EEPROM 25 according to the first embodiment. When the build succeeds, the operator of the mobile terminal 1 approaches the mobile terminal 1 to the memory card 2 and then selects and operates the write key 183c. Then, the data communication unit 14 (see FIG. 2) of the mobile terminal 1 transmits the execution file generated by the control information manager 13 to the memory card 2 via the NFC communication unit 17. The NFCC 24 of the memory card 2 writes the execution file received by the antenna 23 to the EEPROM 25.

Next, the following describes a process procedure of executing the execution file of the program written as described above. The following abbreviates the execution file of the program written to the EEPROM 25 simply as a program.

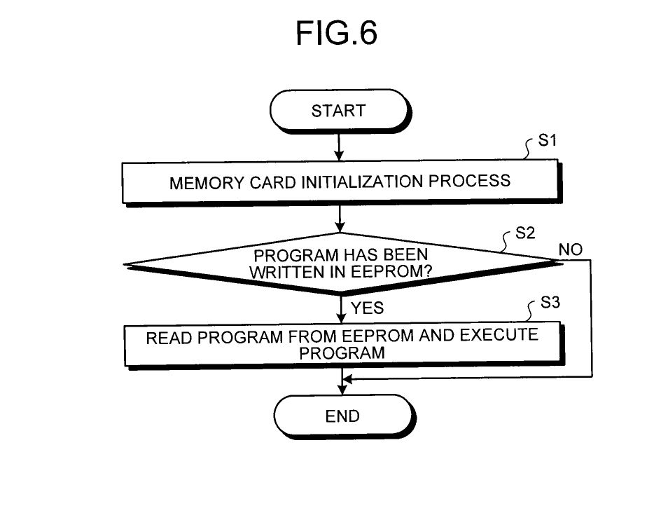

FIG. 6 is a flowchart illustrating an operation process when starting the memory card 2 in the first embodiment. Inserting the memory card 2 into the card slot of the host device 3 supplies the power source to the memory card 2, starts the memory card 2, and starts the initialization process (S1). In the initialization process, the NAND controller 22 performs a process of setting a control value to various registers for operation control or the like. As the start of this initialization process, the NAND controller 22 outputs a busy signal to the host device 3. Then, upon termination of the initialization process, the NAND controller 22 outputs a ready signal to the host device 3 (S1).

Upon termination of the initialization process, the NAND controller 22 determines whether the program has been written in the EEPROM 25 or not (S2). Including the case where the EEPROM 25 is in the initial state, if the program has not been written in the EEPROM 25, the data on the EEPROM 25 are all described as 0xFF. Therefore, when the data in the EEPROM 25 are all described as 0xFF, the NAND controller 22 determines that the program has not been written. If not 0xFF, the NAND controller 22 determines that any program has been written to the EEPROM 25.

If the program has not been written to the EEPROM 25 (S2: No), the NAND controller 22 terminates the process at the start. When the program has been written in the EEPROM 25 (S2: Yes), the NAND controller 22 reads this program from the EEPROM 25 and executes the program (S3). For example, as illustrated in FIG. 3, if the program deleting “ABCD0001.JPG” is described, the NAND controller 22 performs the process of deleting the file “ABCD0001.JPG” stored in the NAND 21, and terminates the process at the start of the memory card 2.

Since the NAND controller 22 deletes the file “ABCD0001.JPG”, the actual data of the file “ABCD0001.JPG” may be physically deleted from the NAND 21. Alternatively, among management data of a file system, information regarding the file “ABCD0001.JPG” may be deleted or changed. In other words, it is only necessary that the host device 3 cannot recognize the file “ABCD0001.JPG” as the file recorded in the memory card 2. It is not always necessary to physically delete the actual data of the file “ABCD0001.JPG” from the NAND 21.

Therefore, in this example, embedding the program of deleting the file “ABCD0001.JPG” in the NAND 21 into the EEPROM 25 from the mobile terminal 1 via the NFC allows automatically deleting “ABCD0001.JPG” at the start of the memory card 2.

The NAND controller 22 may execute the program written in the EEPROM 25 whenever the memory card 2 starts. Alternatively, the NAND controller 22 may execute the program only when starting the memory card 2 for the first time start after writing the program. For execution only the first time start, after completion of the program execution, it is only necessary to enter a flag indicative of completion of execution in the EEPROM 25 by the NAND controller 22, or to delete the executed program from the EEPROM 25, or the like.

The NAND controller 22 may execute the program written in the EEPROM 25 at a timing other than the start of the memory card 2.

For example, in a state where the memory card 2 is inserted into the card slot of the host device 3 (that is, in a state where the memory card 2 has been started), the NFC application 151 of the mobile terminal 1 may transmit the execution instruction. For example, an execute key is newly provided at the operation key 183 of the program input screen 180 (see FIG. 3). Then, upon operation of the execute key, the NFC application 151 outputs the execution instruction of the program to the memory card 2 by the NFC. When the NAND controller 22 receives the execution instruction of the program via the NFC, the NAND controller 22 promptly executes the program in the EEPROM 25.

Alternatively, upon writing of the program to the EEPROM 25, the NAND controller 22 may promptly execute the program. For example, in a state where the memory card 2 is inserted into the card slot of the host device 3, on the NFC application 151 of the mobile terminal 1, the program is input from the program input screen 180 for compilation. When operating the write key 183c, the NFC application 151 transmits the execution file of the program to the EEPROM 25 by the NFC. When the NAND controller 22 detects that the program has been written on the EEPROM 25, the NAND controller 22 promptly executes the program.

Another example is that the NFC application 151 may write information indicative of execution timing of the program (execution flag and the like) in the EEPROM 25 via the NFC to set the execution timing of the program. Then, the NAND controller 22 reads the execution flag indicative of program execution timing from the EEPROM 25 at the start. At the timing indicated by this execution flag, the NAND controller 22 executes the program written to the EEPROM 25.

The timing of execution the program may be every predetermined period, or the NAND controller may execute the program at a predetermined date and time.

Thus, the timing of program execution can be set from the mobile terminal 1 side, ensuring carrying out an execution request of the program at a user's desired timing.

According to the first embodiment, regardless of whether the memory card 2 has started or not, the NFCC 24 writes the program received from the mobile terminal 1 via the NFC to the EEPROM 25. Then, at any of timing after starting the memory card 2, the NAND controller 22 reads the program from the EEPROM 25 and executes the program. As the result of this configuration, without the insertion of the memory card 2 into the card slot, the user can instruct the operation on the data file in the memory card 2 from the mobile terminal 1. This allows obtaining an effect that can improve a convenience of the memory card 2.

### Second Embodiment

The first embodiment describes the example where the mobile terminal 1 compiles the program to convert the program into an executable format, and then transmits the program to the memory card 2. In contrast to this, the second embodiment describes an example of using interpreter system control information sequentially interpreting the program on the memory card 2. The following describes an example of using a command executed while sequentially interpreted as the interpreter system control information. However, a program executed while sequentially interpreted may be used as the control information. The configuration similar to the configuration described in the first embodiment will not be further elaborated here.

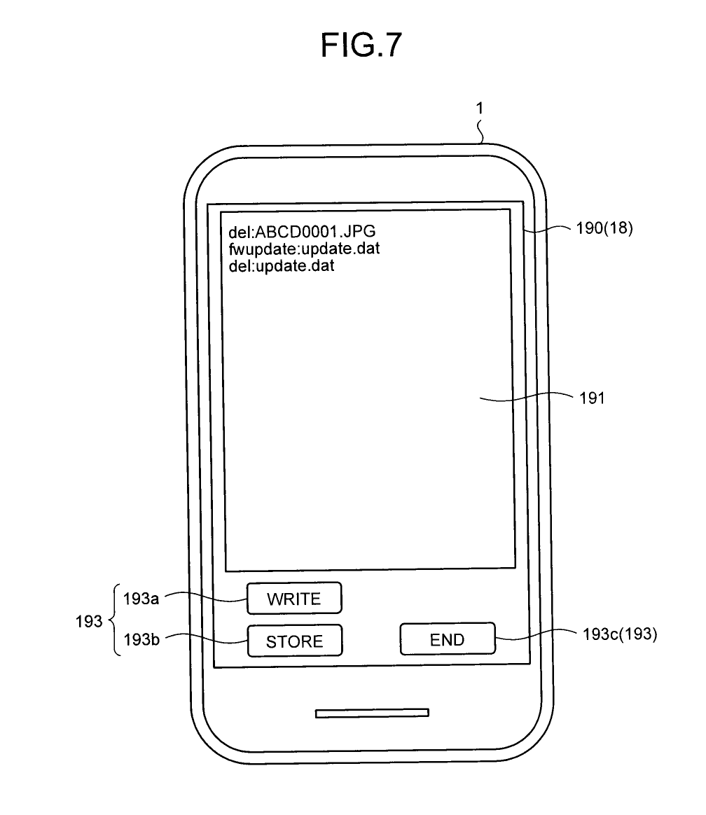

FIG. 7 is a drawing illustrating an exemplary configuration of a command input screen 190 displayed on the mobile terminal 1 in the second embodiment. When the NFC application 151 starts, the display controller 12 displays the command input screen 190 as illustrated in FIG. 7 on the display unit 18. The NFC application 151 may be configured to accept inputs of both the program and the command, and a user may select any one of the inputs at the start of the NFC application 151.

The command input screen 190 includes a command area 191 and various operation keys 193. The command area 191 is an area that displays a command input via the operating unit 19. The example of FIG. 7 describes the command “del:ABCD0001.JPG” that is indicative of deleting “ABCD0001.JPG” stored in the NAND 21 of the memory card 2, on the first line. Here, the file “ABCD0001.JPG” is, similar to the first embodiment, a file accessible by the host device 3 in a state where the memory card 2 is inserted into the card slot of the host device 3.

The second line describes that the command “fwupdate:update.dat” that is indicative of execution the update file “update.dat” stored in the NAND 21 to update a firmware of the memory card 2. Third line describes that the command “del:update.dat” that is indicative of deleting “update.dat” after execution of the update.

The operation key 193 includes a write key 193a, a store key 193b, and an end key 193c. The key configuration is one example: the operation key having another function may further be disposed. The write key 193a is a key that accepts an instruction of writing the command input to the command area 191 to the EEPROM 25 of the memory card 2 via the NFC. The store key 193b is a key that accepts an instruction of storing a command input to the command area 191. The end key 193c is a key that accepts an instruction of terminating the NFC application 151.

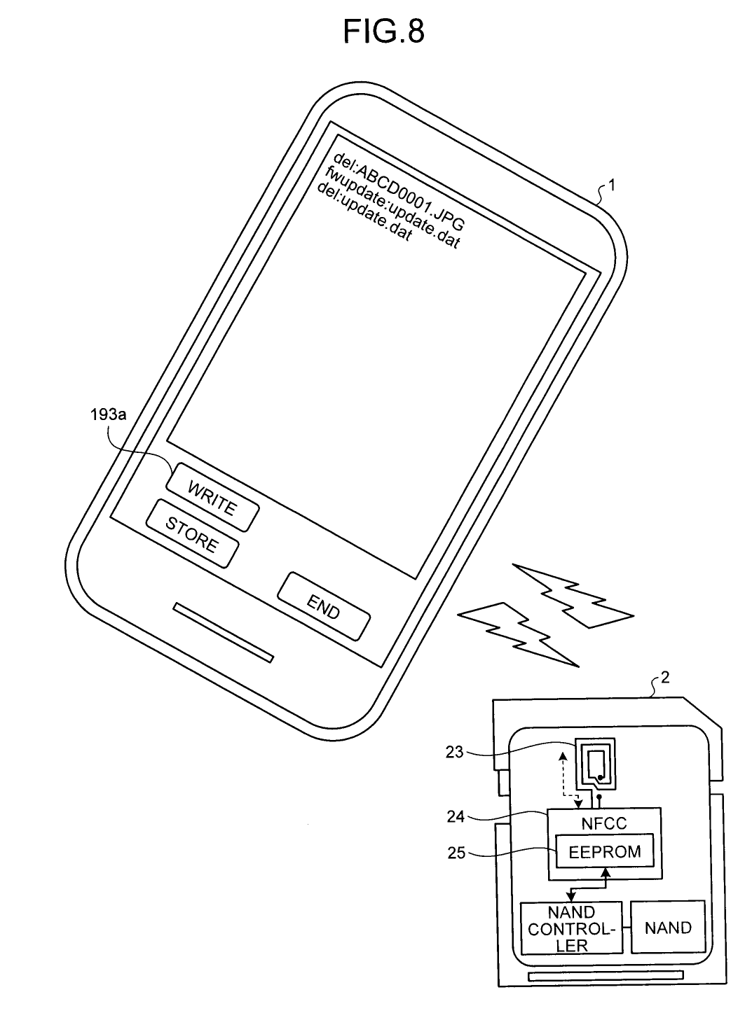

FIG. 8 is an explanatory view schematically illustrating an operation of writing a command on the EEPROM 25 in the second embodiment. The operator of the mobile terminal 1 approaches the mobile terminal 1 to the memory card 2 and then selects and operates the write key 193a. Then, the control information manager 13 of the mobile terminal 1 converts the command input to the command area 191 in accordance with a predetermined command format. Afterwards, the data communication unit 14 of the mobile terminal 1 transmits the command after conversion to the memory card 2 via the NFC communication unit 17. The NFCC 24 of the memory card 2 writes the command received by the antenna 23 to the EEPROM 25.

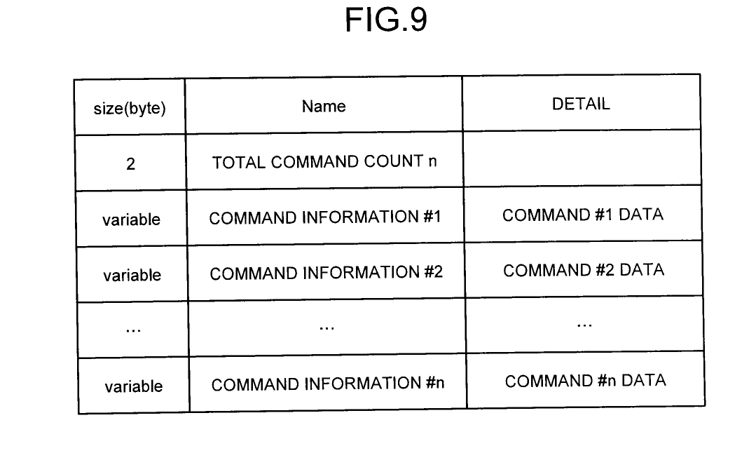

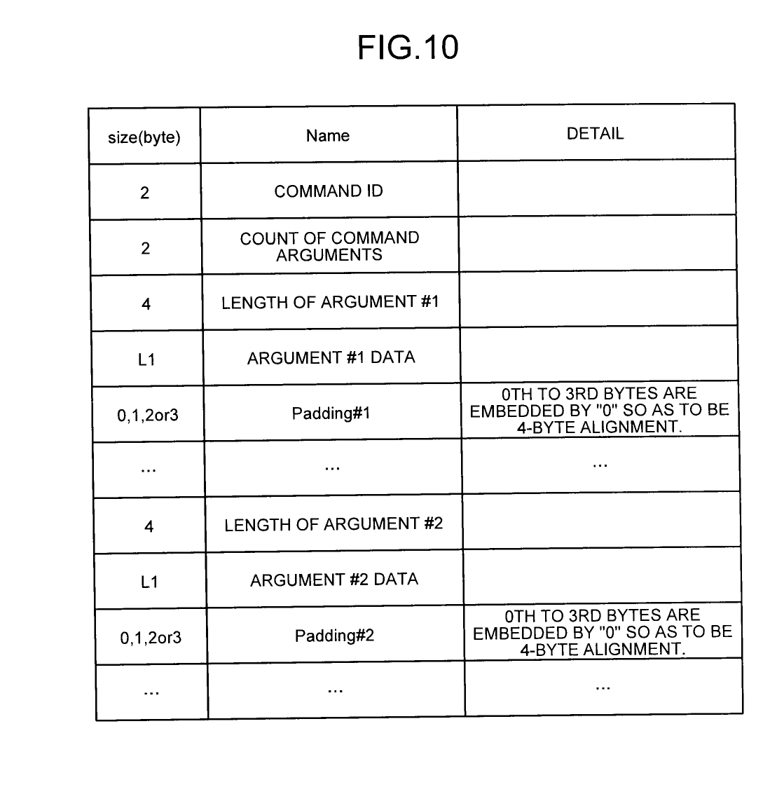

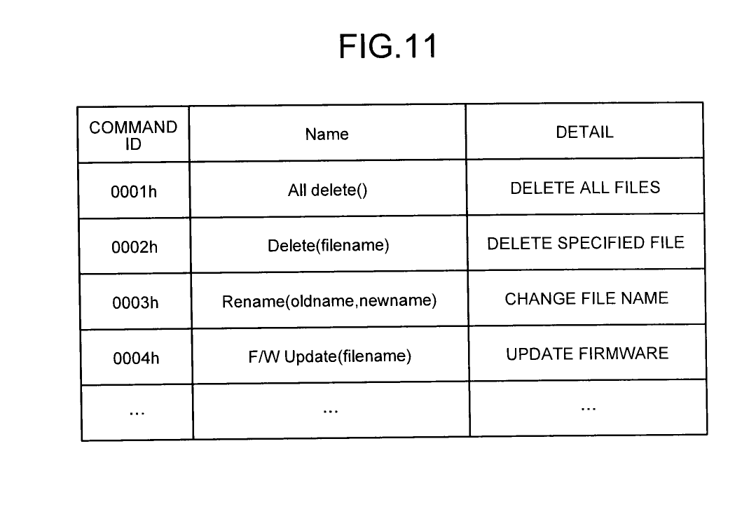

Here, the following describes the command conversion by the control information manager 13 using a concrete example. FIG. 9 to FIG. 11 are exemplary command formats used for command conversion. FIG. 9 to FIG. 11 are exemplary command formats: this embodiment is not limited to these examples. FIG. 9 is a setting example of a command table. FIG. 10 is a setting example of command information. FIG. 11 is a setting example of a command ID.

Since the example of FIG. 7 has three-line commands, at the head of the command table in FIG. 9, a total command count: 3 is set. To the command information #1, the command data regarding “del:ABCD0001.JPG” on the first line is set. To the command information #2, the command data regarding “fwupdate:update.dat” on the second line is set. To the command information #3, the command data regarding “del:update.dat” on the third line is set.

To each command information #1 to #3, a command ID corresponding to the commands is further set based on FIG. 11 as illustrated in FIG. 10. For example, if the command is “del:ABCD0001.JPG”, the command ID: 0002h is set. As a command argument (argument #1), ABCD0001.JPG is set.

The control information manager 13 converts the commands input to the command area 191 using such command format. The data communication unit 14 transmits the commands after conversion to the memory card 2 by the NFC.

When the memory card 2 is inserted into the card slot of the host device 3 and terminates the initialization process at the start, the NAND controller 22 reads the command written to the EEPROM 25. The NAND controller 22 interprets the read command in accordance with the predetermined command format in units of one line and executes the command. For the interpretation of the command, the command format used on the mobile terminal 1 side (FIG. 9 to FIG. 11) may be used. In the command examples illustrated in FIG. 7 or FIG. 8, the NAND controller 22 deletes the data file “ABCD0001.JPG” in the NAND 21, updates the NAND controller 22 by the update file “update.dat” in the NAND 21, and deletes the update file “update.dat” from the NAND 21.

Thus, the NAND controller 22 of the second embodiment has an interpreter function that interprets the commands in units of one line.

The following describes a process procedure of when the NAND controller 22 executes the command written to the EEPROM 25 as described above.

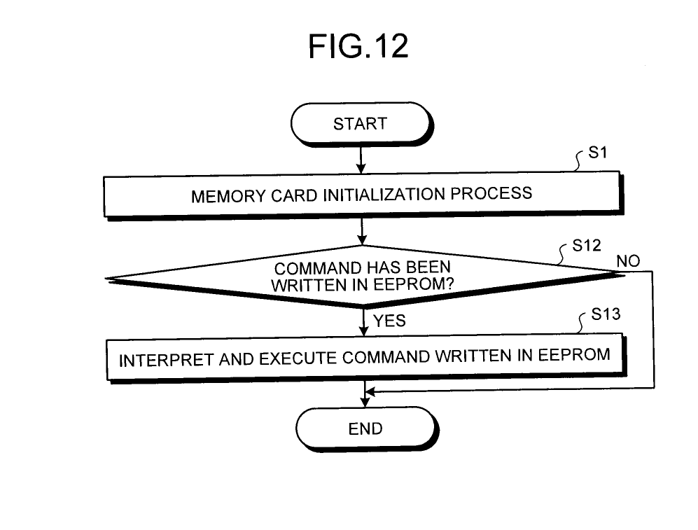

FIG. 12 is a flowchart illustrating an operation process when starting the memory card 2 in the second embodiment. Inserting the memory card 2 into the card slot of the host device 3 supplies the power source to the memory card 2. The memory card 2 starts to start the initialization process (S1). The detail of the initialization process is similar to S1 in FIG. 6; therefore, the process will not be further elaborated here.

When terminating the initialization process, the NAND controller 22 determines whether the command has been written in the EEPROM 25 or not (S12). Including the case where the EEPROM 25 is in the initial state, in a state where the command has not been written to the EEPROM 25, data in the EEPROM 25 are all described as 0xFF. Therefore, when the data in the EEPROM 25 are all described as 0xFF, the NAND controller 22 determines that the command has not been written. If not all described as 0xFF, the NAND controller 22 determines that any command has been written to the EEPROM 25.

If the command has not been written (S12: No), the NAND controller 22 terminates the process at the start. When the command has been written in the EEPROM 25 (S12: Yes), the NAND controller 22 reads this command from the EEPROM 25. The NAND controller 22 interprets the read command in accordance with the predetermined command format in units of one line and executes the command (S13).

According to the second embodiment, after the start of the memory card 2, the memory card 2 can sequentially interpret the command written in the NFC tag 26 for execution. Therefore, according to the second embodiment, similar to the first embodiment, the effect that can improve a convenience of the memory card 2 can be obtained.

The example of instructing the deletion and update of the file by the control information (program or command) is described above. However, the instruction content of the control information is not limited these. As another example, the control information may include an instruction of newly creating a folder or a file in the NAND 21. As another example, the control information may include an instruction of initializing (formatting) the NAND 21.

In the above-described case, the mobile terminal 1 inputs the instruction regarding the data file in the NAND 21 by the program and the command. However, the input method is not limited to this. The NFC application 151 of the mobile terminal 1 may accept the instruction regarding the data file in the NAND 21 via the touch operation to the operating unit 19.

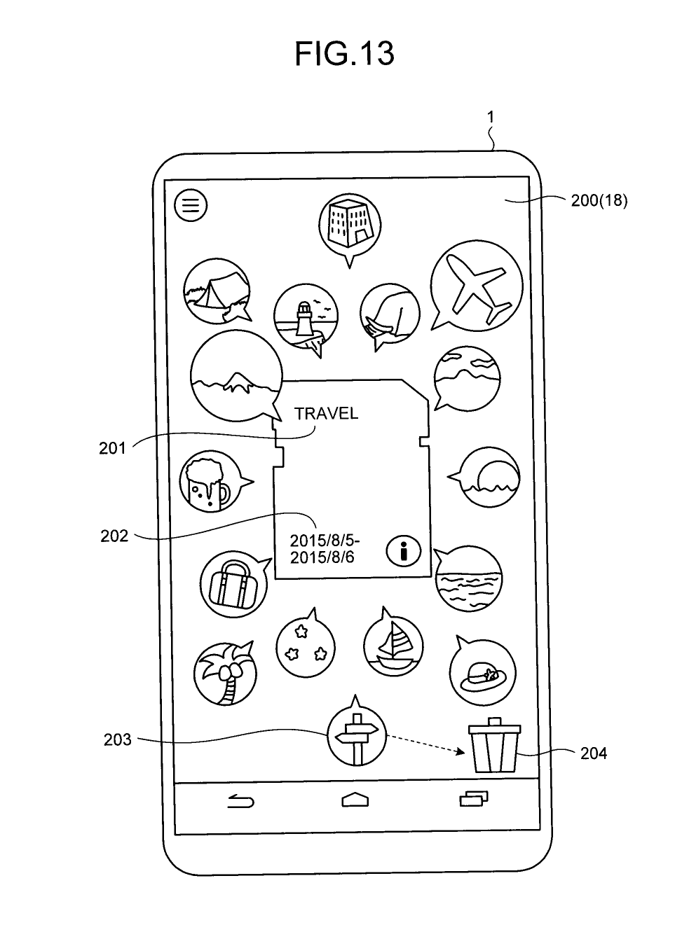

FIG. 13 is a schematic diagram illustrating an exemplary operation method when accepting a user instruction through a touch operation. FIG. 13 illustrates an example of a preview screen 200 displayed on the mobile terminal 1 when holding out the mobile terminal 1 over the memory card 2. That is, the EEPROM 25 of the memory card 2 stores thumbnails of image files stored by the NAND 21. When the mobile terminal 1 and the memory card 2 approach, the NFCC 24 transmits the thumbnail data to the mobile terminal 1 by the NFC. When the NFC application 151 of the mobile terminal 1 receives the thumbnail data via the NFC, the NFC application 151 displays the preview screen 200 arranging the thumbnails on the display unit 18.

As illustrated in FIG. 13, on the preview screen 200, the illustration of the memory card 2, which is a communication target of the NFC, is drawn. The preview screen 200 displays a title 201 added to the memory card 2, and shooting dates 202 for image files stored in the NAND 21. The preview screen 200 also displays plural thumbnails 203 of the image files stored in the NAND 21. Furthermore, the preview screen 200 includes a recycle bin icon 204.

When the user moves the thumbnail 203 of the image desired to be deleted on the recycle bin icon 204 by drag-and-drop operation, the NFC application 151 accepts the instruction of deleting the image file of the original image corresponding to this thumbnail 203 from the NAND 21. Then, the NFC application 151 incorporates identification information by which the thumbnail 203 can be specified, a file name of the thumbnail 203 and the like, into the deletion instruction and transmits the identification information to the memory card 2. The NFCC 24 of the memory card 2 receives this identification information and writes the identification information to the EEPROM 25 as the deletion instruction. The NAND controller 22, similar to the operation described above, at any timing after the start of the memory card 2, deletes the image file of the original image corresponding to the identification information written to the EEPROM 25 from the NAND 21.

FIG. 13 illustrates the example of the drag-and-drop operation of the one thumbnail 203 to the recycle bin icon 204. However, two or more thumbnails may be selected to move the thumbnails to the recycle bin icon 204.

Thus, accepting the deletion instruction via the touch operation on the thumbnail display allows the user to more intuitively instruct the operation on the file in the NAND 21.

FIG. 13 describes the configuration that can select the thumbnail of the file of target for deletion. However, the configuration that can select the file type or the file format of the file of target for deletion may be used. For example, the display unit 18 of the mobile terminal 1 displays the file type (a photograph, a moving image, and the like) or the file format (extension) of the file stored in the NAND 21, and provides checkboxes for each item. The NFC application 151 accepts the command of batch-deleting the files with the selected file type or file format, and generates the control information in accordance with the instruction content.

Alternatively, the data file target for deletion may be selected by the metadata of the data file. As one example, it is only necessary to extract the file target for deletion with the metadata: a created date and a last update date of the file, a person who created the file, a person who updated the file, and a photographing model of the file, and the like. Regarding a date, the created date, the last update date, and the like, it may be configured such that not with the date but with the period, the file target for deletion can be selected.

In the above case, instructions of update of a firmware, a timing of this update, or the like is accepted though the programs and commands. Such instructions may be accepted by a simpler operation via a Graphical User Interface (GUI), a checkbox, a drop menu, and the like.

A configuration that the mobile terminal 1 writes the control information to the NFC tag 26 of the memory card 2 is described above. However, the NFC application 151 of the mobile terminal 1 may perform reading on the NFC tag 26 as well as writing. As one example, the NFC application 151 reads the control information (program, command, or the like) stored in the EEPROM 25 of the NFC tag 26 to display the control information on the display unit 18. The NFC application 151 accepts editing work on the read control information. The NFC application 151 transmits the control information after editing to the NFC tag 26 by the NFC and updates the control information in the EEPROM 25.

In the above, the first embodiment describes the one example of using the compiler language. The second embodiment describes the one example of using the interpreter language. However, the configuration of the programming language is not limited to these examples. As another example, the configuration where the language of the compiler language or the interpreter language is used according to need may be used.

A processor that the NFCC 24 (first controller) includes, a CPU and the like, or a processor that the NAND controller 22 (second controller) includes, a CPU and the like, executes each process explained in FIG. 5, FIG. 6, FIG. 8, FIG. 12, or the like. However, the processes performed by each controller may be configured to be achieved by a circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory device comprising:
a communication unit configured to perform a near field communication;
a non-volatile first memory configured to be accessible by the near field communication;
a non-volatile second memory configured to store a data file;
a first controller configured to write, upon receipt of control information by the communication unit, the received control information to the first memory using electric power generated during the near field communication regardless of whether the memory device has started or not, the control information defining an operation regarding the data file; and
a second controller configured to read the control information from the first memory after the start of the memory device and to execute the read control information.

2. The memory device according to claim 1, wherein
at the start of the memory device, the second controller reads the control information from the first memory and executes the control information.

3. The memory device according to claim 1, wherein
the first controller writes, upon receipt of instruction information indicative of a timing of executing the control information by the communication unit, the received instruction information to the first memory, and
the second controller executes the control information at the timing indicated by the instruction information.

4. The memory device according to claim 1, wherein
the second controller executes, upon receipt of an execution command by the communication unit, the control information.

5. The memory device according to claim 1, wherein
in case the first controller writes the control information received by the communication unit to the first memory, the second controller executes the written control information.

6. The memory device according to claim 1, wherein
the control information defines an operation of deleting a target for deletion, and
the second controller executes the control information after the start of the memory device to delete a data file indicated as a target for deletion in the control information among data files stored in the second memory.

7. The memory device according to claim 6, wherein
in the control information, a certain file format is specified as the target for deletion, and
the second controller executes the control information to delete a data file with the file format specified in the control information among the data files stored in the second memory.

8. The memory device according to claim 6, wherein
in the control information, metadata is specified as the target for deletion, and
the second controller executes the control information to delete a data file including the metadata specified in the control information among the data files stored in the second memory.

9. The memory device according to claim 8, wherein
the control information includes information indicative of a date of a target for deletion as the metadata, and
the second controller deletes a data file among the data files stored in the second memory, the metadata including the date specified in the control information.

10. The memory device according to claim 1, wherein
the control information includes an instruction of an update with an update file, and
the second controller executes the control information after the start of the memory device to read the update file indicated by the control information from the second memory and update the second controller.

11. The memory device according to claim 1, wherein
the first memory stores thumbnail data indicative of a thumbnail of an image file stored in the second memory,
the first controller transmits the thumbnail data stored in the first memory to a communication device, the communication device being configured to perform the near field communication with the memory device,
the communication unit receives identification information of thumbnail data from the communication device, the thumbnail data being selected as a target for deletion at the communication device,
the first controller stores the identification information received by the communication unit in the first memory, and
after the start of the memory device, the second controller deletes an image file from the second memory, based on the identification information stored in the first memory, the image file being an original image of thumbnail data selected as a target for deletion.

12. The memory device according to claim 1, wherein
the communication unit receives an executable format program as the control information by the near field communication.

13. The memory device according to claim 1, wherein
the communication unit receives a command as the control information by the near field communication, the command being executed while sequentially interpreted,
the first controller writes the command received by the communication unit to the first memory, and
after the start of the memory device, the second controller reads the command from the first memory, interprets the read command, and executes the command.

14. A communication device comprising:
a wireless communication unit configured to perform a near field communication with a memory device, the memory device including a communication unit, a non-volatile first memory, and a non-volatile second memory, the communication unit being configured to perform a near field communication, the first memory being configured to be accessible by the near field communication, the second memory being configured to store a data file; and
an input receiver configured to accept an input of control information, the control information defining an operation regarding the data file of the memory device, wherein
the wireless communication unit transmits the control information to the memory device, an input of the control information being accepted by the input receiver.

15. The communication device according to claim 14, wherein
the input receiver accepts an input of a program as the control information, the program defining an operation regarding a data file stored in the second memory of the memory device,
the communication device further comprises a converter configured to convert the input program into an executable file, and
the wireless communication unit transmits the execution file of the program converted by the converter to the memory device.

16. The communication device according to claim 14, wherein
the input receiver accepts an input of a command as the control information, the command defining an operation regarding a data file stored in the second memory, and
the wireless communication unit transmits the command accepted by the input receiver to the memory device.

17. The communication device according to claim 14, wherein
the input receiver accepts an input of a timing of executing the control information, and
the wireless communication unit transmits instruction information indicative of the timing of executing the control information to the memory device.

18. The communication device according to claim 14, wherein
the input receiver accepts an execution instruction of the control information, and
the transmitter transmits the execution instruction accepted by the input receiver to the memory device by a near field communication.

19. The communication device according to claim 14, wherein
the wireless communication unit reads thumbnail data of an image file stored in the second memory from the first memory of the memory device,
the communication device further comprises a display unit configured to display a thumbnail based on the thumbnail data read by the wireless communication unit,
the input receiver accepts a selection operation of the thumbnail data target for deletion, and
the wireless communication unit transmits the control information to the memory device, including identification information of the selected thumbnail data in the control information.

20. The communication device according to claim 14, wherein
the wireless communication unit reads the control information from the first memory of the memory device,
the input receiver accepts editing for the control information, and
the wireless communication unit transmits the control information after editing to the memory device and to update the control information in the first memory.
